(19) United States
(12) Patent Application Publication
(10) Pub. No.: US 2013/0030937 A1
(43) Pub. Date: Jan. 31, 2013

(54) SYSTEMS AND METHODS FOR NETWORK COMMERCE

(71) Applicants: Constancio LARGUIA, Key Biscayne, FL (US); Carlos Gustavo MASLATÓN, Capital Federal (AR); Sebastian Matias BELLORA, Banfield (AR); Agustina COMELLI, Capital Federal (AR); Diego Martin GONZALEZ, San Vicente (AR); Sebastian SISELES, Capital Federal (AR); Pablo LARGUIA, Madrid (ES)

(72) Inventors: Constancio LARGUIA, Key Biscayne, FL (US); Carlos Gustavo MASLATÓN, Capital Federal (AR); Sebastian Matias BELLORA, Banfield (AR); Agustina COMELLI, Capital Federal (AR); Diego Martin GONZALEZ, San Vicente (AR); Sebastian SISELES, Capital Federal (AR); Pablo LARGUIA, Madrid (ES)

(73) Assignee: VENTUMAR S.A., MONTEVIDEO (UY)

(21) Appl. No.: 13/535,943

(22) Filed: Jun. 28, 2012

Related U.S. Application Data
(60) Provisional application No. 61/505,784, filed on Jul. 8, 2011.
(60) Provisional application No. 61/512,441, filed on Jul. 28, 2011.

(51) Int. Cl. G06Q 30/00

(52) U.S. Cl. 705/26.1

(57) ABSTRACT

A method and system in which a profile associated with a profile owner is created, wherein at least a portion of the profile is not publicly accessible. A service request associated with the profile is created. A clearance request is received from a vendor, the clearance request containing clearance request data. The clearance request data is transmitted to the profile owner. A response associated with the clearance request data is received from the profile owner. The vendor is permitted to access the portion of the profile that is not publicly accessible when the response grants access permission to the vendor; and the vendor is restricted from access to the portion of the profile that is not publicly accessible when the response denies access permission to the vendor.

### CROSS-REFERENCE TO RELATED APPLICATIONS

This application is based on and derives the benefit of the filing date of U.S. Provisional Patent Application Nos. 61/505,784, filed Jul. 8, 2011 and 61/512,441, filed Jul. 28, 2011. The entire content of these applications is herein incorporated by reference in their entirety.

### BRIEF DESCRIPTION OF THE DRAWINGS

FIG. 1 is a flow chart for a sample method of initiating a potential transaction according to an embodiment of the invention.

FIG. 2 is an illustration of an example platform for enabling commerce over a network according to an embodiment of the invention.

FIG. 3 is a flow chart for example profile owner and vendor registrations and interactions according to an embodiment of the invention.

FIG. 4 is a flow chart for an example profile access clearance request according to an embodiment of the invention.

FIG. 5 is a flow chart for an example process of assigning a rank to a service request according to an embodiment of the invention.

FIG. 6 is a flow chart for an example vendor sub-user administration according to an embodiment of the invention.

FIG. 7A is a sample screenshot of a profile creation interface according to an embodiment of the invention.

FIG. 7B is a sample screenshot of a profile creation interface according to an embodiment of the invention.

FIG. 7C is a sample screenshot of a profile creation interface according to an embodiment of the invention.

FIG. 7D is a sample screenshot of a profile creation interface according to an embodiment of the invention.

FIG. 8 is a sample screenshot of a service request interface according to an embodiment of the invention.

FIG. 9 is a sample screenshot of a search engine result according to an embodiment of the invention.

FIG. 10 is a sample screenshot of a profile owner administration dashboard interface according to an embodiment of the invention.

FIG. 11 is a sample screenshot of a vendor dashboard interface for administering activities related to profile owners according to an embodiment of the invention.

FIG. 12 is a sample screenshot of a vendor dashboard interface for administering sub-holders according to an embodiment of the invention.

### DETAILED DESCRIPTION OF SEVERAL EMBODIMENTS

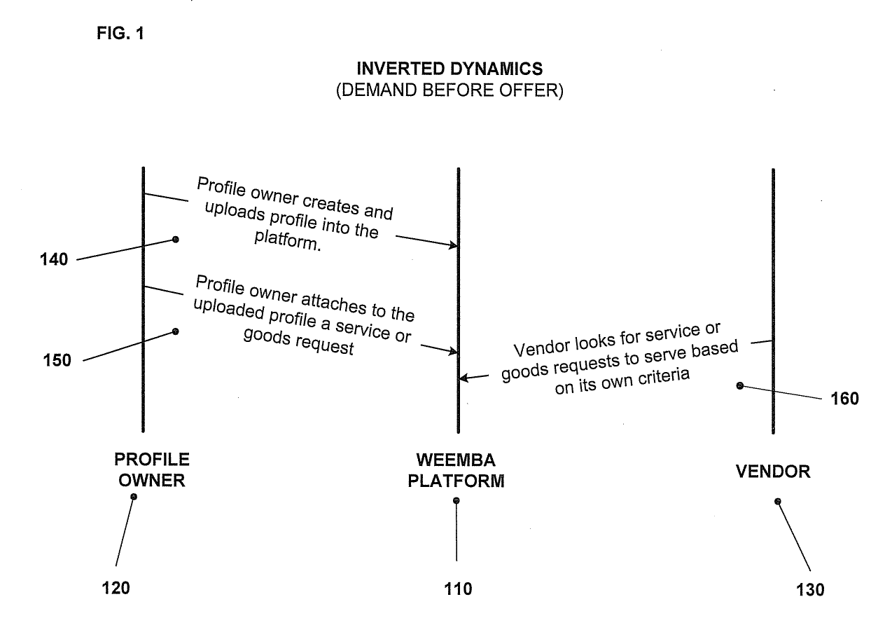

Embodiments of the invention may provide a commercial platform for use over the Internet or another network. The platform may enable third-party users to communicate, initiate a commercial relationship which may later conclude outside the platform, and/or transact a commercial deal within the platform. Separate categories of users may be defined. For example, the platform may support profile owner, vendor, and/or other user categories. Users may be able to connect to the platform through the network and/or directly or locally. FIG. 1 is a flow chart for a sample method of initiating a potential transaction according to an embodiment of the invention. A computer associated with a potential buyer of goods or services 120 may connect to the platform server 110 and the potential buyer may create a personal profile 140, thus becoming a profile owner. The profile may include information about the profile owner's nature as a potential customer. Some portions of the profile may be publicly viewable and others may be private, or the entire profile may be private. A profile owner may post a service request 150 describing goods or services in which the profile owner is interested. For example, a company could post a profile and service request for a $2 million loan. The company may include information in their profile about their financial projections, whether they already have debts with lenders, credit scores for the company, etc. A computer associated with a vendor 130 may connect to the platform and a vendor may search and/or view service requests 160. Vendors who are interested in fulfilling a service request may request permission to view the private profile of the profile owner associated with the request. If permission is granted, a vendor may be able to view some or all of the complete profile, which may contain information useful in guiding a vendor's decision to fulfill the service request. For example, a vendor such as a bank or other loan provider may use information in the service request and/or profile to inform a decision about whether to offer a loan to the company. Embodiments of the invention may be constructed and arranged to facilitate these interactions.

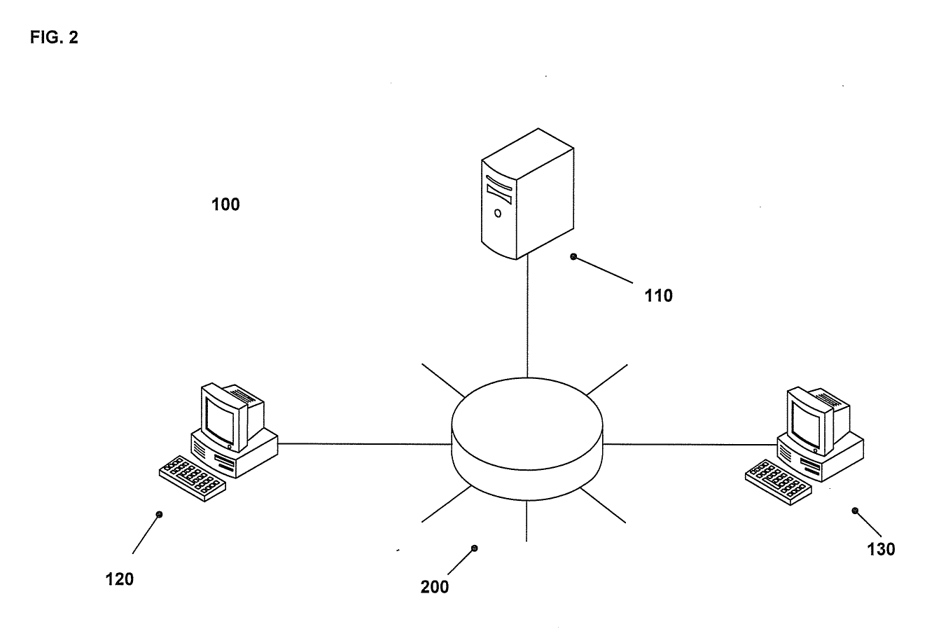

FIG. 2 is an illustration of an example platform 100 for enabling commerce over a network according to an embodiment of the invention. The platform 100 may comprise at least one server 110 which may be placed in communication with at least one network 200 such as the Internet or other suitable networks. The servers 110 may be one or more computers. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, and other terms. It will be understood by those of ordinary skill that those terms used herein are interchangeable, and any computer capable of performing the described functions may be used.

Other computers may be connected to the network 200. For example, at least one profile owner computer 120 associated with at least one profile owner and/or potential profile owner may be able to communicate with the server 110 through the network 200. Also, at least one vendor computer 130 associated with at least one vendor and/or potential vendor may be able to communicate with the server 110 through the network 200.

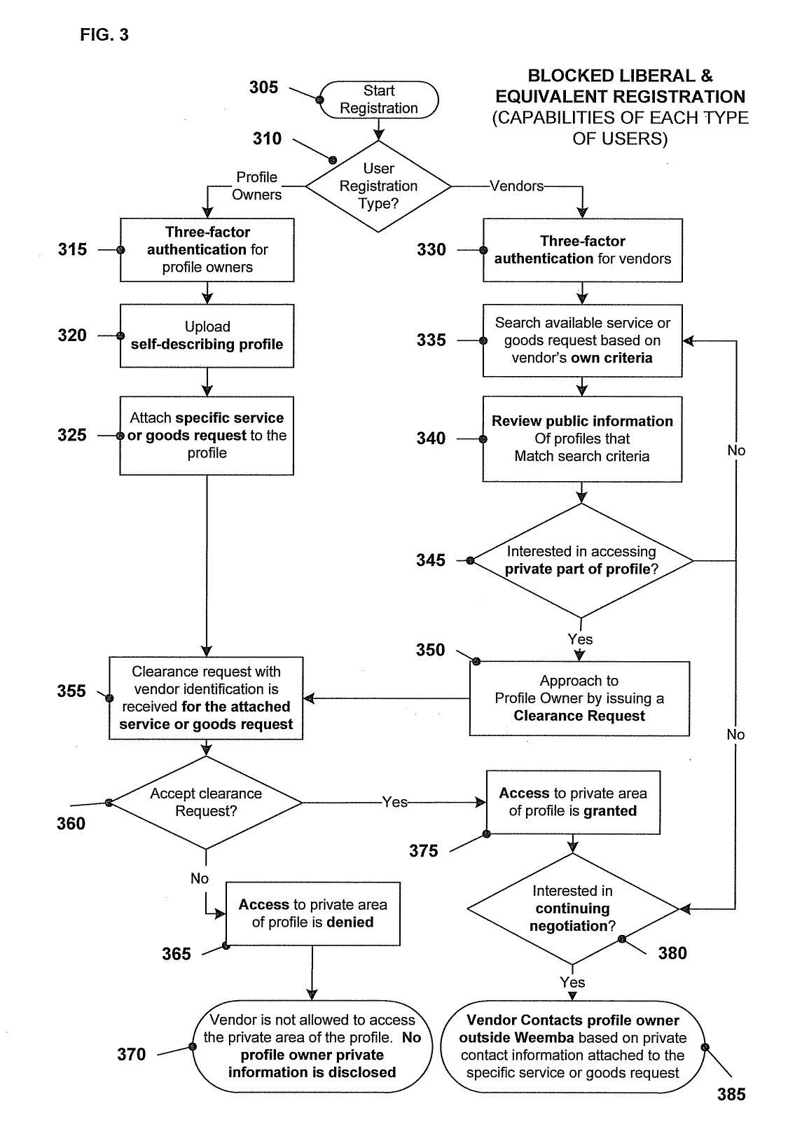

FIG. 3 is a flow chart for example profile owner and vendor registrations and interactions according to an embodiment of the invention. Each category of registered user may have different functions enabled or disabled within the platform. For example, in some embodiments a profile owner may have the following set of capacities:

Creating a self-describing profile which may include a private area where true identity, contact details, and certain private files may be stored.

Participating in forums, posting written comments.

Reviewing public areas of nickname-protected profiles and service requests created within the platform.

Reviewing the status of clearance requests that other nickname-protected profile owners have received from different vendors.

Creating service requests associated with their profile stating an intention to retain the described service.

Granting and/or rejecting clearance requests issued by vendors to access the private area of their profile.

Profile owners may be unable to directly approach vendors.

Profile owners may be unable to access personal information stored in the private area of other profile owners within the platform.

Similarly, in some embodiments a vendor may have the following set of capacities:

Participating in forums, posting written comments.

Reviewing public areas of the nickname-protected profiles and/or service requests created within the platform.

Approaching profile owners by issuing a clearance request when the vendor is interested in having access to the private area of their profile.

Gaining access, subject to profile owners' case-by-case approval, to personal information of accepting profile owners participating in the platform.

Vendors may be unable to create a self-describing profile.

Vendors may be unable to promote a service offering or publicize their services.

As seen in FIG. 3, users may be able to register with the platform and eventually become a specific type of user. In this example, a user may access the platform 305 by using a computer to communicate with the server 110 through the network 200. The communication may include accessing a software user interface associated with the server 110. The platform may prompt the user to specify a user type 310 to proceed with registration.

In some cases, a user may opt to become a profile owner. The platform server 110 may authenticate profile owners 315. One example of an authentication may be a three-factor authentication which may be a process of three steps used to validate a user's identity. A user may first be asked to enter a name, social security number, address, driver's license or other ID number, phone number, and/or other identifying information. The information may be examined to validate data consistency. In some embodiments, the information may be sent to a third party provider who may carry out the examination. If the provided information is consistent with known data about the user, a second factor may be pursued. This second factor may be a question or questions about the user which may in some cases be delivered by a third party provider. Some example questions may require the user to indicate which of a set of credit card or account numbers belong to them, at which of a set of banks they have a mortgage, on which of a set of streets they have resided, or the like. A correct answer may cause a third factor to be pursued. This third factor may involve requesting information about a bank account wherein an undisclosed amount of money may be deposited. The server 110 may direct the user to check their bank account and report the exact amount deposited by the platform or third party provider. For example, $0.71 could be wired to the bank account. If the user correctly reports that $0.71 has been deposited into their account, the third factor may be passed. If all factors are satisfied by the user, their identity may be verified and they may be granted access to the platform.

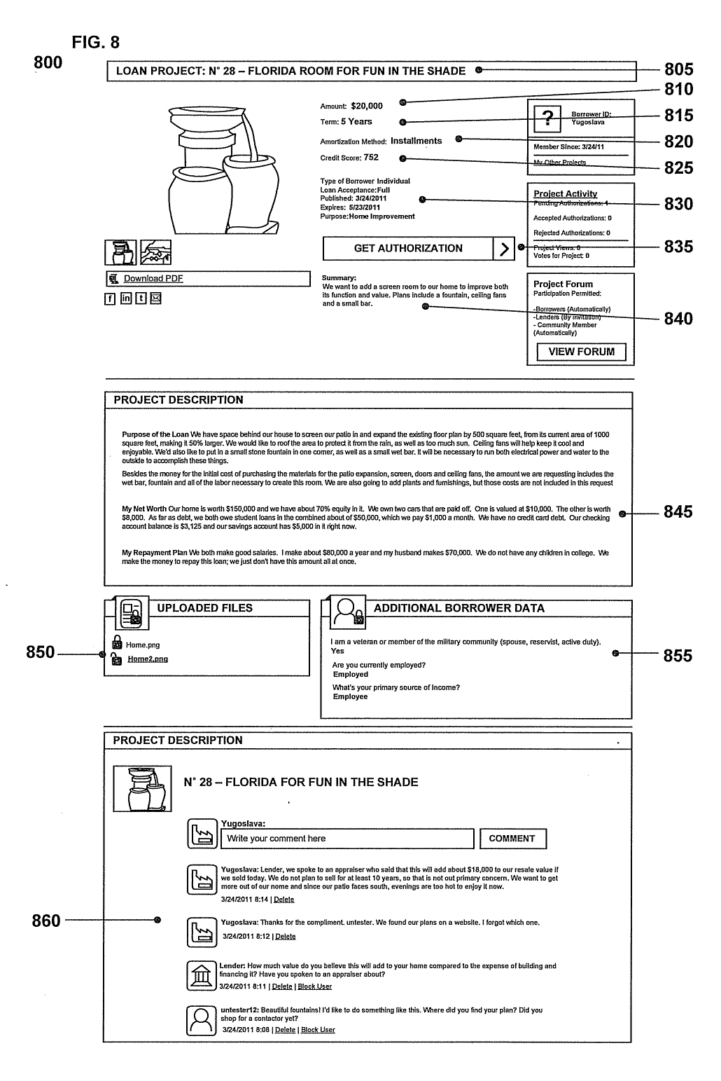

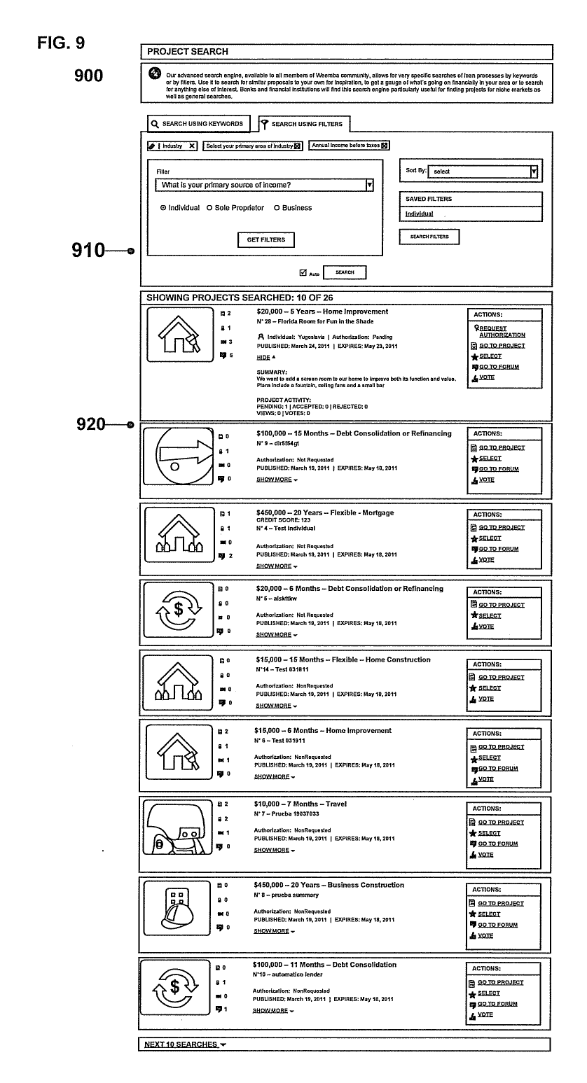

When a user is registered as a profile owner, the platform server 110 may allow the user to upload a self-describing profile 320. A profile owner may be able to create a nickname or ID which may be displayed publicly in place of their actual identity. The actual identity may be included in the private portion of the profile. When a profile owner has a profile, the platform server 110 may allow them to create service requests and associate them with the profile 325. These actions will be described in greater detail with reference to FIGS. 8 and 9 below.

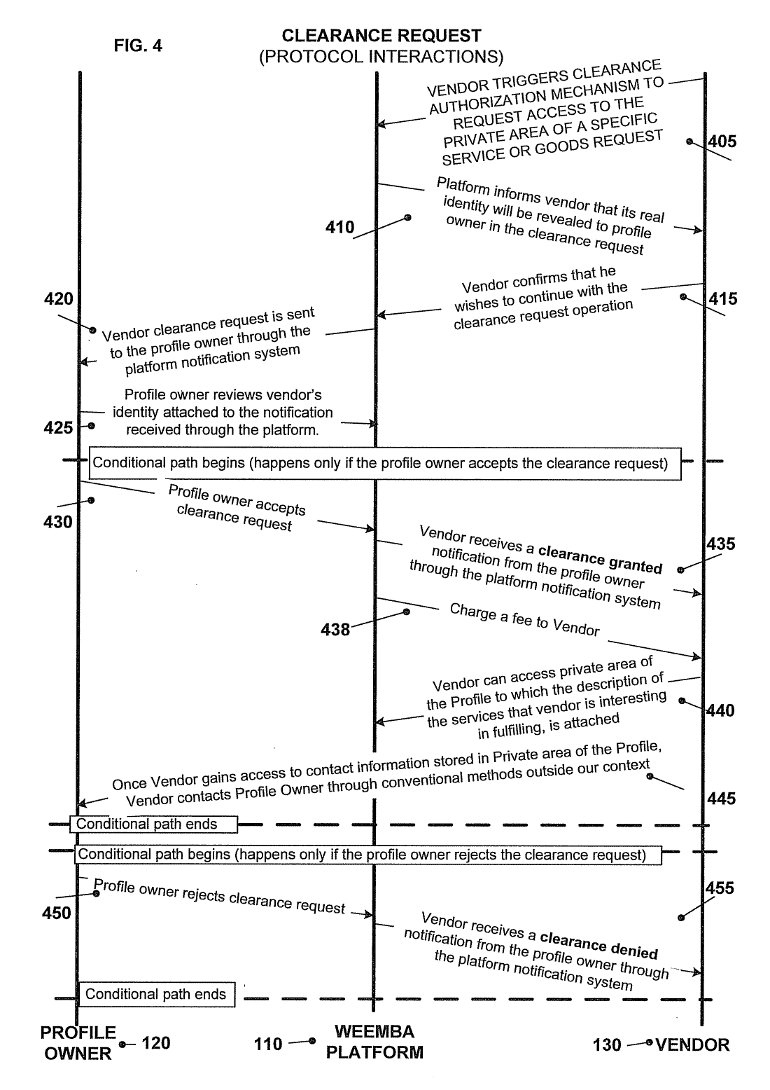

In some cases, a user may opt to become a vendor. The platform server 110 may authenticate vendors 330. For example, the platform server 110 may use a three-factor authentication as described above. When a user is registered as a vendor, the platform server 110 may allow the user to search and/or view available service requests using vendor-specified criteria 335 and/or review public information of profiles that match the search criteria 340. In some cases, a vendor may review public information from a profile and/or a search request and become interested in accessing the private portion of the profile 345. The vendor may also wish to view the private portion of the profile, perhaps after communicating with the profile owner through chat sessions or forums which may be provided by the platform server 110 in some embodiments. The platform server 110 may allow the vendor to issue a clearance request 350 to the profile owner. The clearance request may be a request to access the private profile information. The platform server 110 may deliver the clearance request to the profile owner 355 and the profile owner may choose to accept or reject the clearance request 360. If the platform server 110 receives a rejection from the profile owner, vendor access to the private portion of the profile may be denied 365 and no private information may be disclosed to the vendor 370 by the platform. If the platform server 110 receives an acceptance from the profile owner, vendor access to the private portion of the profile may be granted 375. The vendor may review the private information and decide whether to continue negotiation for delivery of the requested good or service with the profile owner 380. Using information in the private portion of the profile, the vendor may then contact the profile owner using a channel outside the platform 385. These actions will be described in greater detail with reference to FIGS. 4 and 9 below.

FIG. 4 is a flow chart for an example profile access clearance request according to an embodiment of the invention. As described above, a vendor may submit a clearance request to a profile owner. In this example, this may begin when the platform server 110 receives a clearance authorization request 405 sent by a vendor computer 130. The platform server 110 may transmit a confirmation request 410 to the vendor computer 130. In some embodiments the confirmation request may include a warning that the vendor's identity may be revealed to the profile owner through the clearance request. The platform server 110 may receive an answer to the confirmation request 415. A negative answer received from the vendor computer 130 may terminate the clearance request process. A positive answer received from the vendor computer 130 may cause the platform server 110 to transmit the clearance request 420 to the profile owner computer 120 associated with the request. The clearance request sent to the profile owner computer 120 may be identical to the one received from the vendor computer 130, or the platform server 110 may send a different clearance request containing at least some of the same information. The platform server 110 may receive a response to the clearance request 425 from the profile owner computer 120.

In some cases, the response to the clearance request from the profile owner computer 120 may indicate that the profile owner has accepted the request 430. The platform server 110 may transmit a clearance granted notification 435 to the vendor computer 130. In some embodiments, the platform server 110 may charge a fee to the vendor 438. This may be done in any manner, for example by debiting an account associated with the vendor, transmitting a message to the vendor computer 130 indicating that a fee must be paid before access to a profile will be granted, or in some other way. The platform server 110 may allow the vendor computer 130 to access private areas of the profile associated with the clearance request 440. In some cases, the private area may contain contact information which may allow a vendor to directly contact a profile owner 445.

In other cases, the response to the clearance request from the profile owner computer 120 may indicate that the profile owner has rejected the request 450. The platform server 110 may transmit a clearance denied notification 455 to the vendor computer 130.

Embodiments of the platform server 110 may calculate a rank for profiles and/or service requests created by profile owners. The rank may be based on the level of information made available to vendors by a profile and/or a service request associated with the profile. The rank may be used to facilitate profile searches by vendors, which are described in more detail with respect to FIG. 9 below. For example, the position in which service requests may be listed in a set of search results may be based on service request ranks as well as search criteria relevance and/or other factors. The rank of a service request and/or its associated profile may affect the order in which search results may be displayed. A service request may be of interest or not to a vendor based on the underlying profile. For example, a bank considering granting an unsecured loan may not only base the loan decision on the nature of the loan presented in the service request (i.e. whether the loan request is for an amount that they are in capacity of lending), but also on the nature of the profile owner posting the request (i.e. the credit score of the profile owner, the profile owner's net worth, etc.). Service requests positioned near the top of a search result list may be there for two reasons: 1) the nature of the service request is that one that corresponds to the vendor's searched interests, and 2) the profile owner that authored that service request has attached personal information that may allow the vendor to evaluate whether inherent qualities of the profile owner may be acceptable to the vendor as indicated, for example, by the rank of the request. In some embodiments, condition number 1 described above must be met for a service request to be listed. That is, regardless of the rank in which service requests appear after a search, all results may effectively meet condition number 1. Within the results that meet condition number 1, a rank may be applied as described with respect to condition number 2. If a service request meets condition number 2, but does not meet condition number 1, it may be be listed in the search results at any ranking level in these embodiments. Alternative embodiments, in which requests not meeting condition number 1 may be displayed, are also possible.

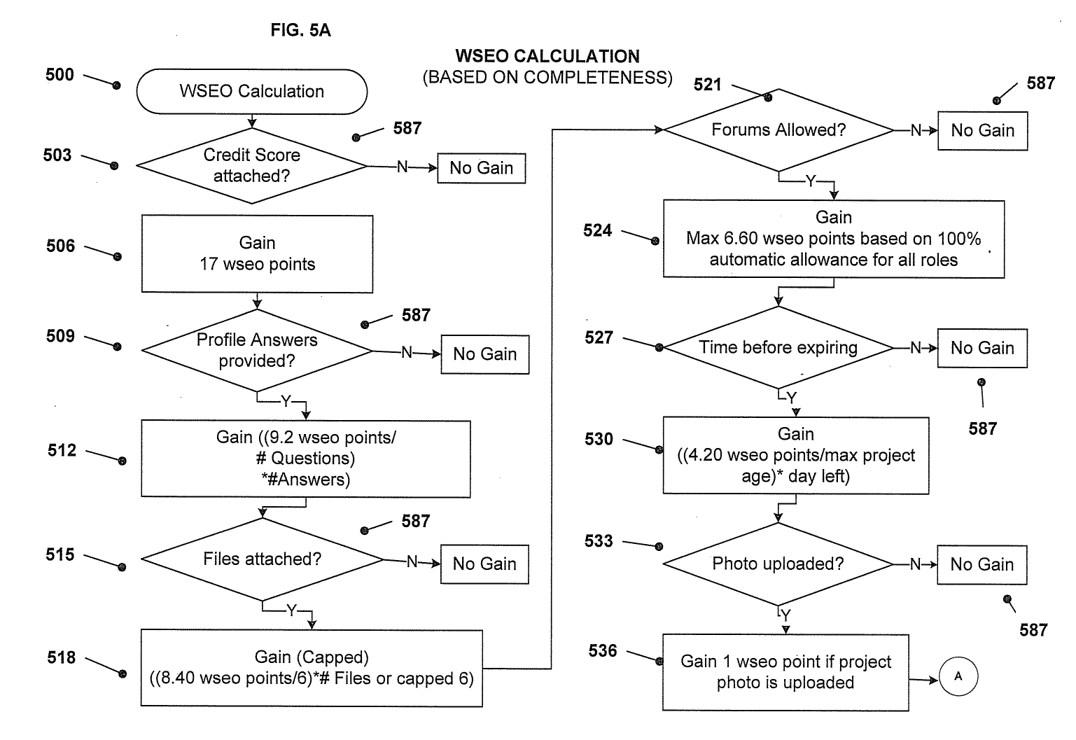

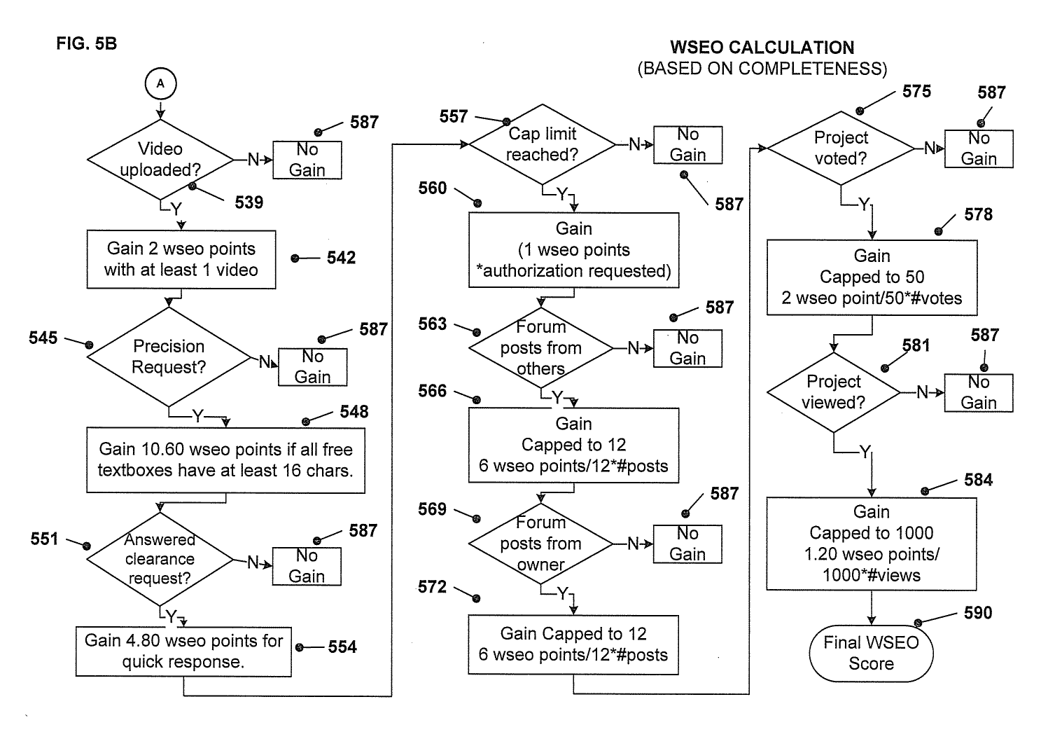

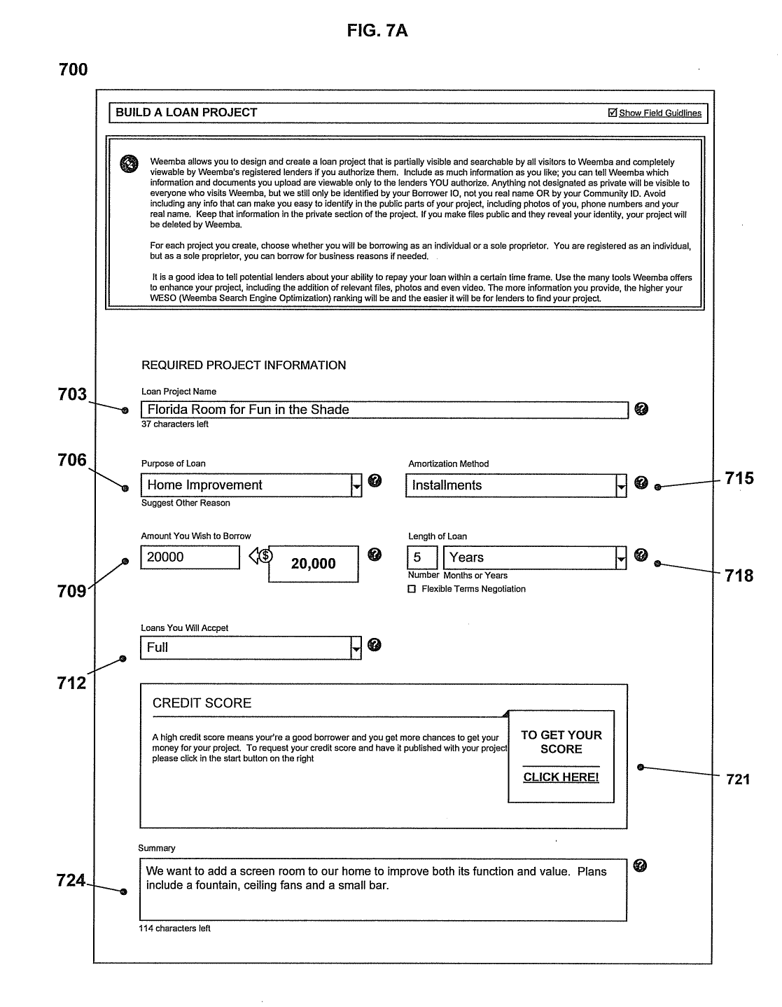

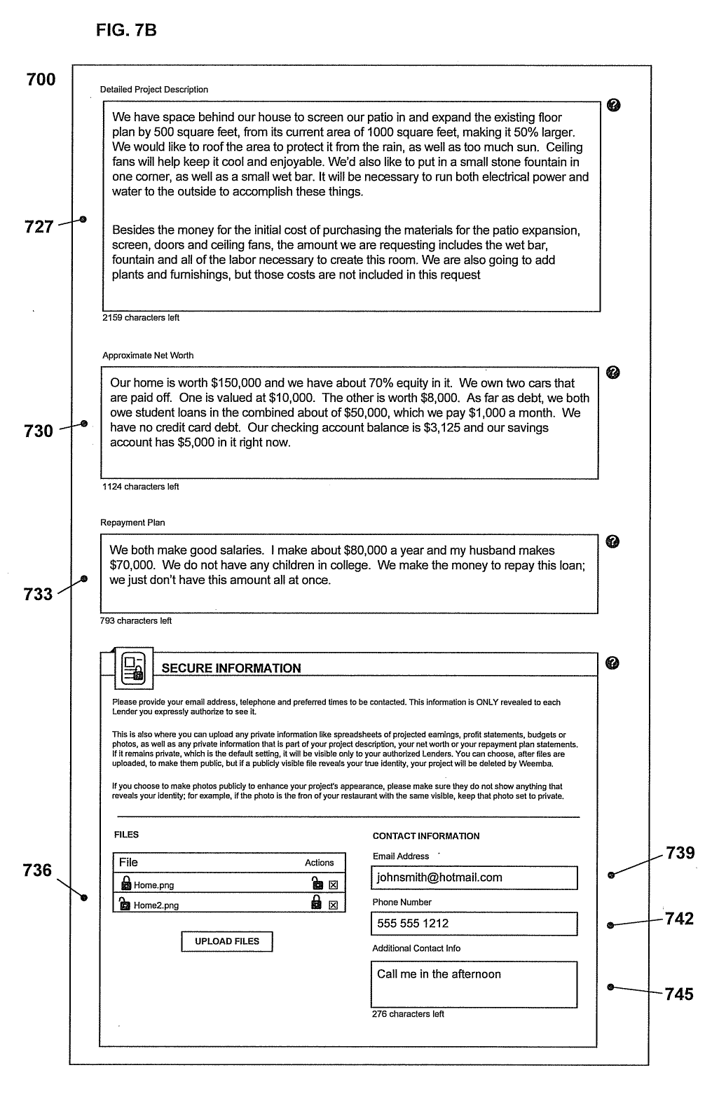

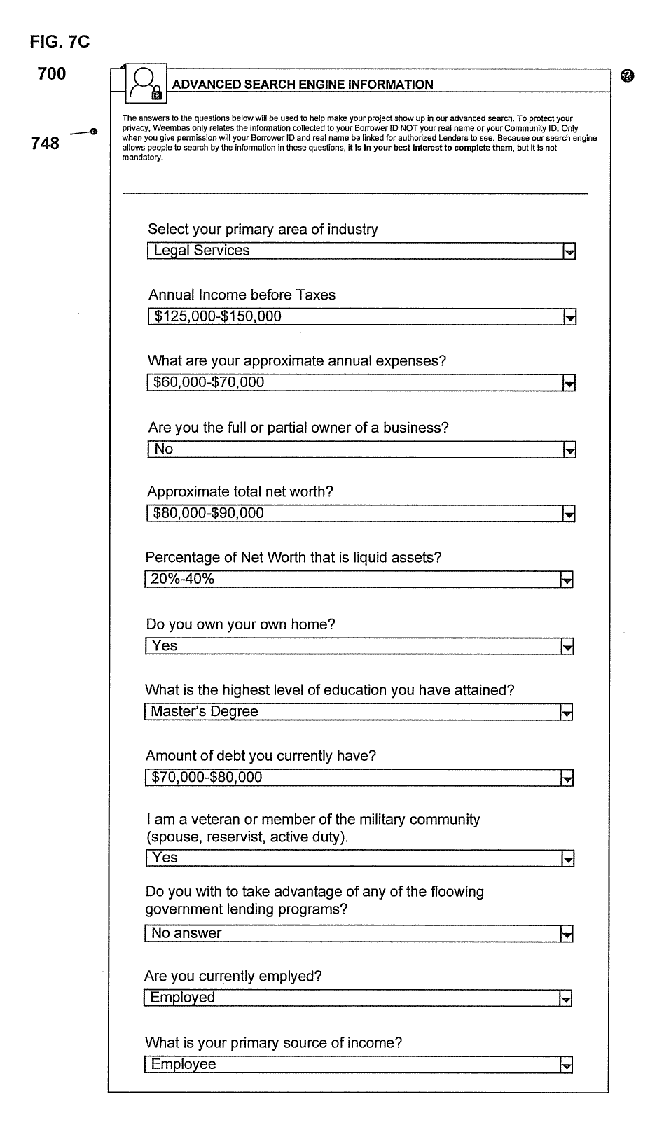

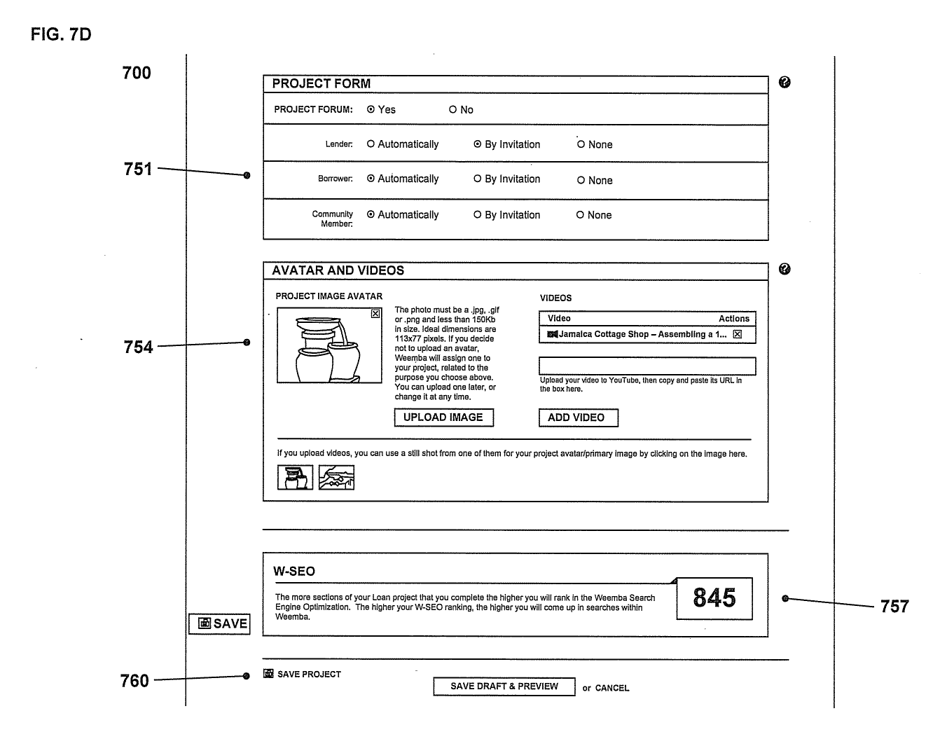

FIG. 5 is a flow chart for an example process of assigning a rank to a profile and/or service request according to an embodiment of the invention. A profile and/or service request may be ranked 500 by the platform server 110 according to various criteria. The criteria presented in this figure may be changed in form, order, variables being considered, and/or values assigned to the variables in other embodiments. In this example, the profile and/or service request may be examined to determine whether a credit score is included 503. If not, no gain for adding a credit score may be applied to the rank of the profile and/or service request 587. If so, a gain for adding a credit score may be applied 506. Similarly, the profile and/or service request may be examined to determine whether profile answers are included 509, files are attached 515, forums are allowed 521, time remains before profile and/or service request expiration 527, photos are included 533, videos are included 539, requests are precise 545, clearance requests have been answered 551, a cap limit has been reached 557, forum posts from other users are present 563, forum posts from owners are present 569, a project associated with the profile and/or service request has been voted on 575, and/or a project associated with the profile and/or service request has been viewed 581. In the above examinations, if the criteria has not been satisfied, no gain may be applied 587. If criteria are satisfied, gains may be applied for profile answers 512, files attached 518, forums allowed 524, time remaining before profile and/or service request expiration 530, photos included 536, videos included 542, request precision 548, clearance requests answered 554, cap limits reached 560, forum posts from other users present 566, forum posts from owners present 572, projects voted on 578, and/or projects viewed 584; as applicable. The platform may generate a final rank or score 590 for a profile and/or service request by adding the gains applied to the profile and/or service request for satisfied criteria. A creator of a profile and/or service request may be able to view the score generated by the platform. For example, the score generated by the platform may be viewable in an interface such as that described with respect to FIG. 7 below.

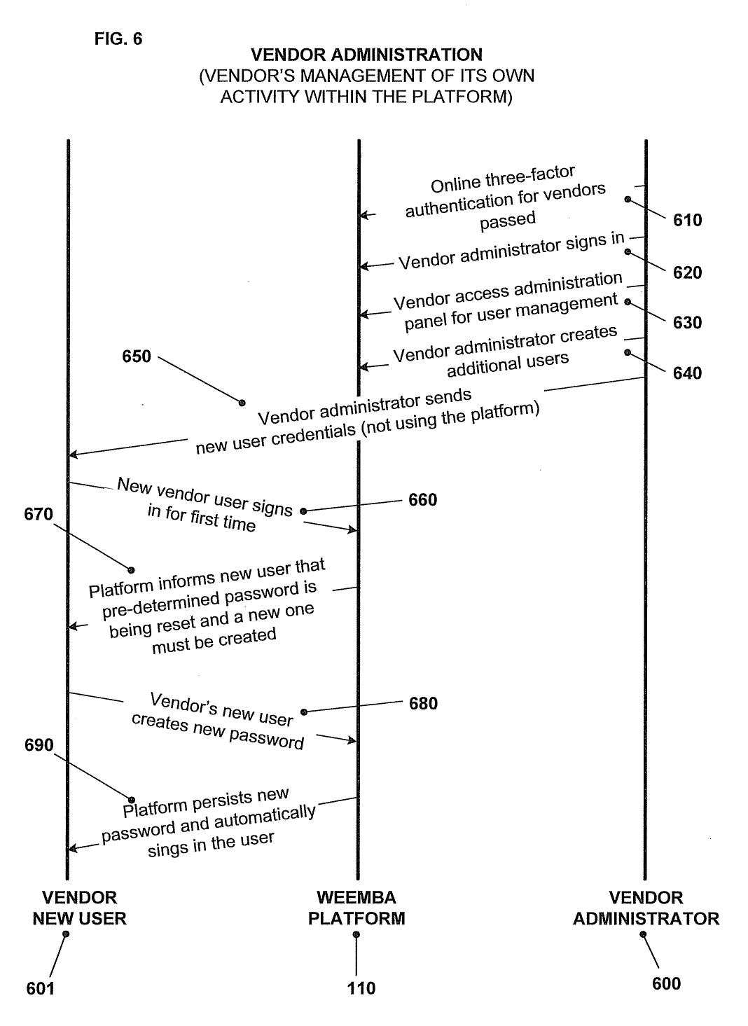

In some embodiments, the platform server 110 may allow vendors to comprise multiple users which may include vendor administrators and vendor sub-users managed by vendor administrators. FIG. 6 is a flow chart for an example vendor sub-user administration according to an embodiment of the invention. One or more vendor computers 130 may be vendor administrator computers 600 in communication with the platform server 110. The platform may receive authentication 610 and vendor administrator sign in 620 from the vendor administrator computer 600. The platform server 110 may allow a vendor administrator computer 600 to access administrative functions 630 and create sub-users 640. Sub-users may have access to all vendor functions or some subset thereof. The platform server 110 may grant access to sub-users entering valid sub-user information. A vendor administrator may give such information to sub-users 650. Thereafter, the platform server 110 may receive sub-user sign in 660 from a sub-user computer 601. The platform server 110 and/or the vendor administrator may have generated a temporary password for a sub-user computer 601 to transmit the first time the associated sub-user accesses the platform server 110. In this case, the platform server 110 may inform the sub-user computer that the password may be reset 670. The platform server 110 may receive a reset password from the sub-user computer 601. The platform server 110 may reset the password accordingly and sign in the sub-user 690.

FIGS. 7A-7D are sample screenshots of a profile creation interface 700 according to an embodiment of the invention. In this example, a profile and service request for a loan are shown. Other types of profiles and/or service requests are possible. Some elements of the profile creation interface 700 may be used to create a profile, and other elements may be used to create service requests associated with the profile. Additional elements may be included and/or some shown elements may be omitted in various embodiments of profile creation interfaces 700.

Elements 703-718 may be provided that enable a profile owner to generate basic information about a service request. In the loan request example shown, project name 703, purpose 706, amount to be borrowed 709, loan type 712, amortization method 715, and loan length 718 fields may be provided. A profile owner may include a third-party provided credit score in the profile 721 in some embodiments. For other types of service requests, different fields may be used. For example, if the service request is related to the tourism industry (i.e. a request for a travel package), the fields may not be financially oriented as in FIGS. 7A-7D, but may instead enable a user to enter information referring to tourism preferences that the profile owner may have.

Elements 724-733 may be provided that may allow a profile owner to enrich the description of the profile and/or service request in more extensive and personalized ways than the parameterized fields described above. For example, a profile owner may be able to write a summary 724, detailed description 727, and/or repayment plan 733 for a service request. A profile owner may also be able to write a description of their net worth 730, which may be included either in the private profile along with the private information described below, or in the public portion of the profile. In other examples, such as the tourism example, fields may be provided that enable the profile owner to describe different details (i.e. tourism interests).

Elements 736-745 may enable a profile owner to enter private information that may be revealed to vendors who receive approval from the profile owner to have access to the private profile. For example, this private information may include the true identity of the profile owner who may be identified in the public profile with a nickname, private files 736, and contact information such as an email address 739, phone number 742, and/or additional contact information 745.

The interface 700 may provide search engine optimization information fields 748 that the profile owner may complete in order to increase the detail present in the profile and potentially improve related service request rankings for searches. The information entered into these fields 748 may be made part of the private profile, but may also be used to calculate ranks for service requests as described above with respect to FIG. 5. In the context of FIG. 5, the answers provided for questions presented in the fields 748 of FIG. 7C may be “profile answers”. Completing the fields 748 may be optional, and the platform may advise a profile owner that completing the fields 748 may improve search rankings for associated service requests in some embodiments. The type of information requested by these fields 748 may vary depending on the type of service request(s) being created. For example, the fields 748 shown in FIG. 7C may be used for a loan type service request (such as annual income, net worth, education level, debt level, etc.), whereas for a tourism service requests the fields may include planned dates, hotel preferences, restaurant preferences, tourist attraction preferences, and the like. This information may be fed to statistically oriented tools to calculate a variety of demographic and economic data. Based on the information generated as profiles are created, as well as through the interaction of profile owners and vendors within the platform server 110, a variety of statistically oriented data may be made accessible to platform server 110 users.

The interface 700 may allow a profile owner to create and/or enable a forum where messages can be posted by vendors, other profile owners, and/or general platform server 110 users. A project forum field 751 may be provided with options for forum creation. The interface 700 may allow granting access to such forum either automatically or by invitation.

A profile owner may be able to upload or attach pictures, video, and/or other files to the profile using a media upload field 754.

A ranking result for the profile and/or a service request associated with the profile, which may be formed by the process described with respect to FIG. 5 or in some other way, may be displayed 757.

The interface 700 may allow the profile owner to save a draft of a service request and/or profile in process of being built and/or a completed service request and/or profile 760.

FIG. 8 is a sample screenshot of a service request 800 according to an embodiment of the invention. This example is a service request 800 for a loan. Other service request 800 types may be possible. A service request 800 may include a title 805, amount requested 810, term requested 815, amortization method requested 820, credit score 825, and/or public information 830 about the profile owner and service request 800. In other embodiments some of these elements may not be present, or additional elements may be added. In some embodiments, service requests may have expiration dates. These may be automatically assigned expiration dates, or expiration dates may be specified by a profile owner creating the request.

A vendor viewing this example service request 800 may be able to request clearance to the private portion of the profile, for example by clicking an authorization request button 835. In some embodiments, a vendor may be charged a fee by the platform server 110 if the profile owner approves the authorization request made upon clicking this request button 835, as described above.

A brief summary 840 of the service request 800 may be displayed. Also, a description 845 of the service request 800 may be displayed. In some cases this description 845 may provide more detail than the summary 840. Files, such as images, videos, or documents, may have been attached to the service request 800 by the profile owner. If so, the files may be accessible through an uploaded files display 850. Personal information 855 about the profile owner may be displayed. The personal information 855 may be less information than is available in the private portion of the associated profile. In some embodiments, the personal information 855 may only be accessible to vendors who are registered with the platform server 110. A forum 860 may be present. A profile owner and other users may be able to engage in dialog using the forum 860. A profile owner may be able to specify whether to automatically allow, allow by invitation only, or not allow some or all other users to participate in forums 860 associated with their service requests and/or profile.

FIG. 9 is a sample screenshot of a search engine 900 according to an embodiment of the invention. Other search engine 900 formats and options may be possible. This search engine 900 may be used by vendors and/or others. For example, vendors may use the search engine 900 to target profiles, profile owners, and/or service requests of interest based on parameters that the vendors index for such targeting purposes. A search field 910 may be provided to allow vendors to enter search terms. Service requests and/or profiles or portions, summaries, and/or previews thereof may be displayed 920 after a search is run. In some embodiments, the search engine 900 may optimize its searching capabilities by utilizing an algorithm that may rank the searched results based on their level of completeness in terms of amount of information incorporated in the ranked profiles as well as community activity on such profiles, in addition to correlation between searched terms and information in the profiles. In some embodiments, the platform server 110 may communicate information about service requests and/or public profiles to a vendor computer 130 even when the vendor has not performed a search. For example, the search engine 900 may be able to periodically search for vendor specified or platform specified parameters automatically and display the results to a vendor, and/or a vendor may be able to specify criteria that enable the platform server 110 to deliver information about service requests and/or public profiles that match the criteria as they are published.

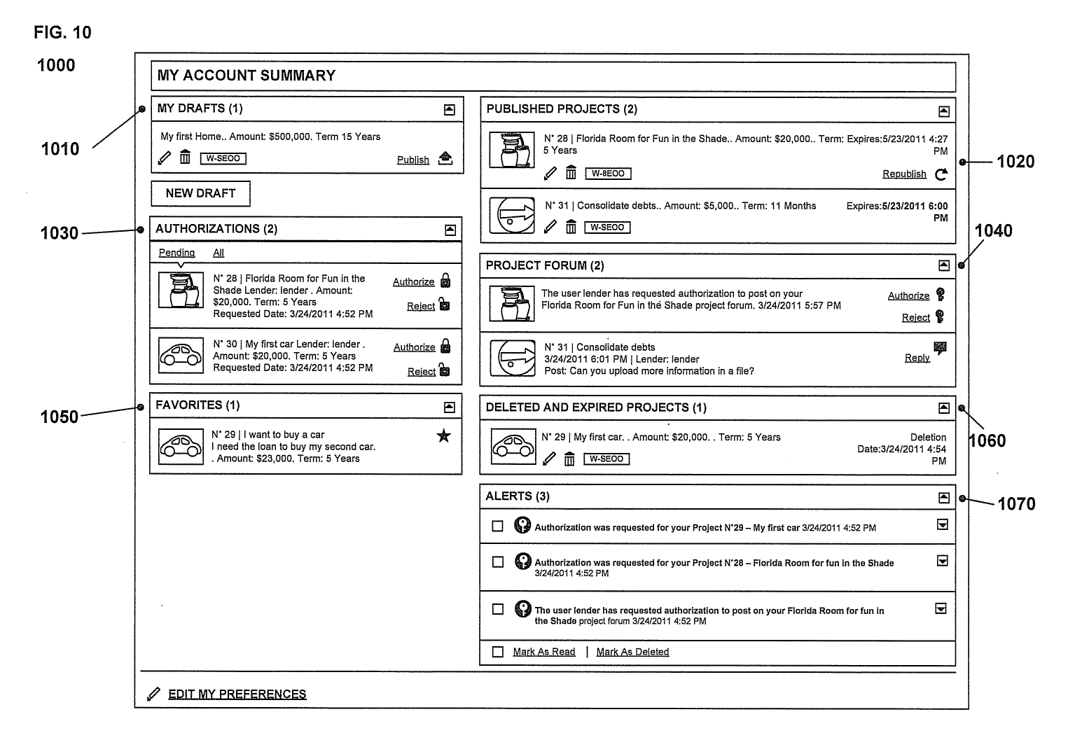

FIG. 10 is a sample screenshot of a profile owner administration dashboard interface 1000 according to an embodiment of the invention. The dashboard 1000 may be an interface which may allow a user to access functions which may be provided through the dashboard 1000 or in separate interfaces linked from the dashboard 1000. Some functions in this example may not be present in all embodiments, and some embodiments may provide additional functions. The dashboard 1000 may provide access to a function for administering and/or editing drafts which may ultimately be published as service requests or deleted 1010. Another function may allow a profile owner to edit, delete, republish, and/or administer already published service requests 1020. Another function may display clearance requests issued by vendors 1030. From this area, the profile owner may be able to authorize or reject access to the private area of her profile. A function for receiving and displaying comments posted in forums 1040 may be provided. This function 1040 may allow the profile owner to read and respond to comments in forums in which the forum owner may have elected to participate. Another function may display those service requests that, though published by other profile owners, may be of interest to the profile owner for any reason 1050. These service requests published by others may be selected by the profile owner, presented to the profile owner by the platform server 110, or chosen some other way. A function may display and/or provide access to those service requests that the profile owner had once published but that have either expired or have been retired from exposure by her 1060. With this function 1060, the profile owner may be able to edit, delete, and/or republish the service requests. Another function in this example may enable a profile owner to receive messages or notifications from the platform server 110 or other sources 1070. The profile owner may be able to read, delete, and/or organize such messages:

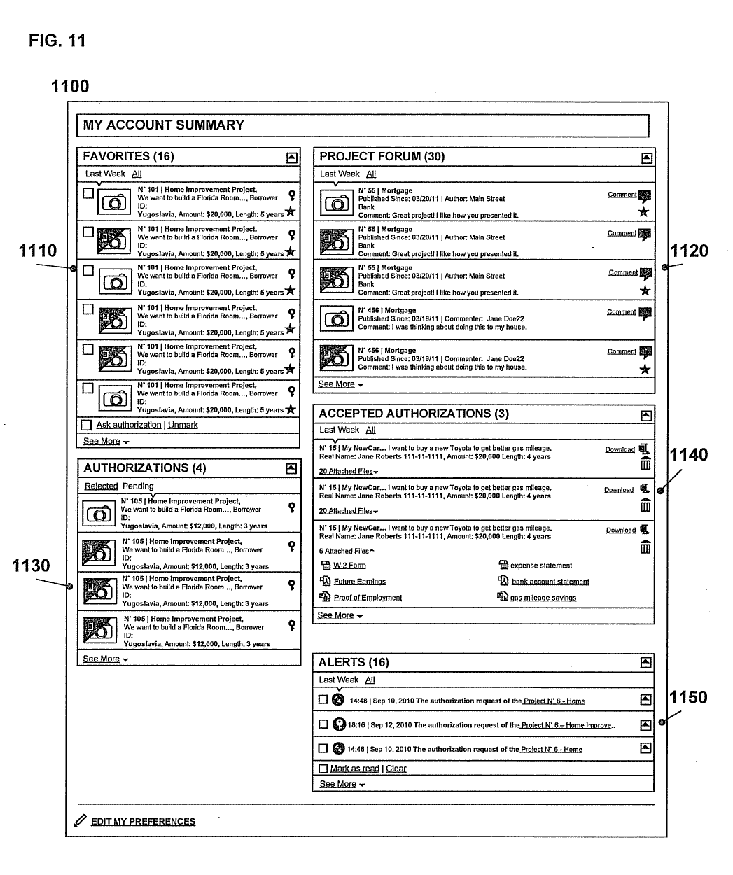

FIG. 11 is a sample screenshot of a vendor dashboard interface 1100 for administering activities related to profile owners according to an embodiment of the invention. The dashboard 1100 may be an interface allowing a user to access functions which may be provided through the dashboard 1100 or in separate interfaces linked from the dashboard 1100. Some functions in this example may not be present in all embodiments, and some embodiments may provide additional functions. In embodiments wherein multiple users may be associated with one vendor, different functions may be provided to different users, or all users may have the same functions available. A function may provide access to service requests and/or profiles that the vendor may have selected as of preliminary interest 1110, in some cases after conducting a generic search through the platform server 110. This function may also allow the vendor to issue a clearance request to be sent to the profile owner associated with the service request and/or profile. Preliminarily selected service requests and/or profiles may also be deselected or erased in some embodiments. Another function may give the vendor access to communications which may be taking place in forums associated with those service requests in which the vendor has elected to participate 1120. This function 1120 may allow the vendor to read, delete, and/or further comment in such forums. One function in this example may enable the vendor to access and/or delete pending or rejected clearance requests 1130. Another function may provide vendor access to service requests and/or profiles associated with granted clearance requests 1140. This function 1140 may allow the vendor to read the complete service request, have access to the attached files blocked to non-authorized users, download files containing some or all of the information included in the service request, obtain compressed files containing some or all of the information included in the service request, delete the service request, and/or other functions. Another function may provide vendor access to messages or notifications from the platform server 110 or other sources 1150. The vendor may be able to read, delete, and/or organize such messages.

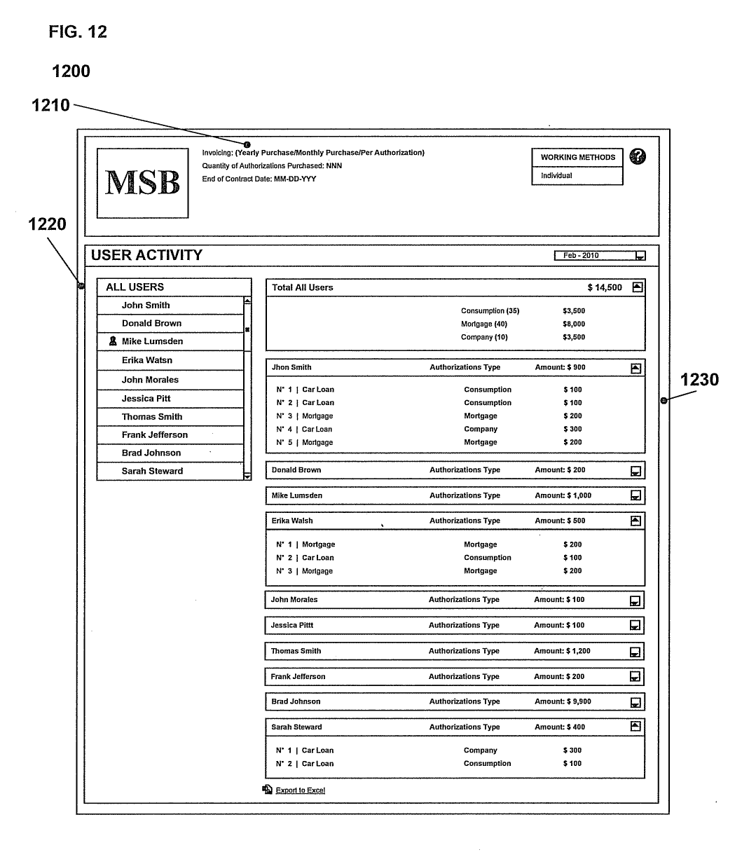

FIG. 12 is a sample screenshot of a vendor dashboard interface 1200 for administering sub-users according to an embodiment of the invention. The dashboard 1200 may be an interface allowing a user to access functions which may be provided through the dashboard 1200 or in separate interfaces linked from the dashboard 1200. Some functions in this example may not be present in all embodiments, and some embodiments may provide additional functions. One function may allow an authorized administrator for a vendor to review current terms of a contract which may exist between the vendor and a platform server 110 operator 1210. Another function may enable an administrator to review a list of sub-users that may have been granted an enabled identity and/or permission to issue clearance requests 1220. Another function may permit the administrator to review clearance requests issued by sub-users 1230. This function 1230 may display amounts of accepted clearance requests issued and/or the costs to the vendor associated with those clearance requests for a given period. The function 1230 may also allow the administrator to export the information to a file which may be stored on a local computer.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than those shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A system comprising:
a platform computer constructed and arranged to:
receive a profile instruction to create a profile from a profile owner, wherein at least a portion of the profile is not publicly accessible;
create the profile;
receive from the profile owner a service request instruction to create a service request associated with the profile;
create the service request;
receive a clearance request from a vendor, the clearance request containing clearance request data;
transmit the clearance request data to the profile owner;
receive a response associated with the clearance request data from the profile owner;
permit the vendor to access the portion of the profile that is not publicly accessible when the response grants access permission to the vendor; and
restrict the vendor from access to the portion of the profile that is not publicly accessible when the response denies access permission to the vendor.

2. The system of claim 1, wherein the platform server is further constructed and arranged to charge a fee to the vendor when the response grants access permission to the vendor.

3. The system of claim 2, wherein:
the platform server is further constructed and arranged to communicate with a network; and
the fee is charged to the vendor through the network.

4. The system of claim 1, wherein the platform server is further constructed and arranged to communicate with a network.

5. The system of claim 4, wherein the platform computer receives the profile instruction, the service request instruction, the clearance request, and the response through the network.

6. The system of claim 1, wherein the platform computer is further constructed and arranged to operate a search engine associated with the service request.

7. The system of claim 1, wherein:
the platform computer is further constructed and arranged to generate a rank for the profile and/or the service request; and
the profile and/or the service request comprise a feature and the rank is based on the feature.

8. The system of claim 7, wherein the platform computer is further constructed and arranged to operate a search engine associated with the service request and the rank for the service request.

9. The system of claim 7, wherein generating the rank comprises:
determining whether a gain element is present in the profile and/or service request; and
adding a gain for each gain element present in the profile and/or service request.

10. The system of claim 9, wherein the gain element comprises a credit score, a profile answer, a forum, a time remaining before profile and/or service request expiration, a photo, a video, a detail level, a response to the clearance request data, a reached cap limit, a forum post, a vote associated with a project, and/or a viewing associated with a project is present in the profile and/or service request.

11. The system of claim 1, wherein the profile and/or the service request comprise a feature;
the feature including a credit score, a profile answer, an attached file, a forum, a service request description, an included video, and/or an included picture.

12. The system of claim 11, wherein the platform computer is further constructed and arranged to:
transmit a profile question to the profile owner; and
receive the profile answer associated with the profile question.

13. The system of claim 1, wherein the portion of the profile that is not publicly accessible includes a true identity of the profile owner, profile owner contact information, and/or a private file.

14. The system of claim 1, wherein the platform computer is further constructed and arranged to operate a profile owner dashboard interface and/or a vendor dashboard interface.

15. The system of claim 14, wherein:
the vendor dashboard interface comprises a vendor administrator interface and a vendor sub-user interface; and
the platform server is further constructed and arranged to receive commands through the vendor administrator interface that affect the vendor sub-user interface.

16. The system of claim 1, wherein the platform server is further constructed and arranged to:
receive a request to become a profile owner and/or a vendor from a user;
designate the user as a profile owner and/or as a vendor in response to the request; and
associate the profile owner and/or the vendor with a nickname.

17. The system of claim 16, wherein the platform server is further constructed and arranged to receive the nickname from the user.

18. The system of claim 1, wherein the platform server is further constructed and arranged to:
transmit an authentication test to the profile owner and/or to the vendor;
receive an answer to the authentication test from the profile owner and/or from the vendor;
receive the profile instruction, service request instruction, and/or response from the profile owner and/or receive the clearance request from the vendor when the answer is correct; and
refuse the profile instruction, service request instruction, and/or response from the profile owner and/or refuse the clearance request from the vendor when the answer is incorrect.

19. The system of claim 18, wherein the authentication test comprises:
a question about an identity of the profile owner and/or the vendor;
a question about an activity and/or a property of the profile owner and/or the vendor; and
a question about a financial transaction involving a bank account associated with the profile owner and/or the vendor.

20. A method comprising:
receiving a profile instruction to create a profile from a profile owner with a platform computer, wherein at least a portion of the profile is not publicly accessible;
creating the profile with the platform computer;
receiving from the profile owner a service request instruction to create a service request associated with the profile with the platform computer;
creating the service request with the platform computer;
receiving a clearance request from a vendor with the platform computer, the clearance request containing clearance request data;
transmitting the clearance request data to the profile owner with the platform computer;
receiving a response associated with the clearance request data from the profile owner with the platform computer;
permitting the vendor to access the portion of the profile that is not publicly accessible when the response grants access permission to the vendor; and
restricting the vendor from access to the portion of the profile that is not publicly accessible when the response denies access permission to the vendor.

21. The method of claim 20, further comprising charging a fee to the vendor when the response grants access permission to the vendor with the platform computer.

22. The method of claim 21, wherein the fee is charged with the platform computer through a network.

23. The method of claim 20, wherein the profile instruction, the service request instruction, the clearance request, and the response are received with the platform computer through a network.

24. The method of claim 20, further comprising generating a rank for the profile and/or the service request with the platform computer, wherein the profile and/or the service request comprise a feature and the rank is based on the feature.

25. The method of claim 24, wherein generating the rank comprises:
determining whether a gain element is present in the profile and/or service request with the platform computer; and
adding a gain for each gain element present in the profile and/or service request with the platform computer.

26. The system of claim 25, wherein the gain element comprises a credit score, a profile answer, a forum, a time remaining before profile and/or service request expiration, a photo, a video, a detail level, a response to the clearance request data, a reached cap limit, a forum post, a vote associated with a project, and/or a viewing associated with a project is present in the profile and/or service request.

27. The method of claim 20, wherein the profile and/or the service request comprise a feature;
the feature including a credit score, a profile answer, an attached file, a forum, a service request description, an included video, and/or an included picture.

28. The method of claim 27, further comprising:
transmitting a profile question to the profile owner with the platform computer; and
receiving the profile answer associated with the profile question with the platform computer.

29. The method of claim 20, wherein the portion of the profile that is not publicly accessible includes a true identity of the profile owner, profile owner contact information, and/or a private file.

30. The method of claim 20, further comprising:
receiving a request to become a profile owner and/or a vendor from a user with the platform computer;
designating the user as a profile owner and/or as a vendor in response to the request with the platform computer; and
associating the profile owner and/or the vendor with a nickname with the platform computer.

31. The method of claim 30, further comprising receiving the nickname from the user with the platform computer.

32. The method of claim 20, further comprising:
transmitting an authentication test to the profile owner and/or to the vendor with the platform computer;
receiving an answer to the authentication test from the profile owner and/or from the vendor with the platform computer;
receiving the profile instruction, service request instruction, and/or response from the profile owner with the platform computer and/or receiving the clearance request from the vendor with the platform computer when the answer is correct; and
refusing the profile instruction, service request instruction, and/or response from the profile owner with the platform computer and/or refusing the clearance request from the vendor with the platform computer when the answer is incorrect.

33. The method of claim 32, wherein the authentication test comprises:
a question about an identity of the profile owner and/or the vendor;
a question about an activity and/or a property of the profile owner and/or the vendor; and
a question about a financial transaction involving a bank account associated with the profile owner and/or the vendor.
